(19) United States
(12) Patent Application Publication
(10) Pub. No.: US 2023/0151454 A1
(43) Pub. Date: May 18, 2023

(54) PROCESS FOR THE RECOVERY OF GOLD FROM CARBON FINES WASTE

(71) Applicant: PROCESS RESEARCH ORTECH INC., Mississauga (CA)

(72) Inventors: Md. Abdul HALIM, Mississauga (CA); Jonathan CHEN, Mississauga (CA); Vaikuntam I. LAKSHMANAN, Mississauga (CA); Sankar DASGUPTA, Mississauga (CA)

(21) Appl. No.: 18/054,721

(22) Filed: Nov. 11, 2022

Related U.S. Application Data
(60) Provisional application No. 63/278,664, filed on Nov. 12, 2021.

(51) Int. Cl. C22B 11/00; C22B 3/12

(52) U.S. Cl. CPC C22B 11/04; C22B 3/12

(57) ABSTRACT

A process for the recovery of gold from carbon fines waste, which are produced, especially from carbon-in-leach (CIL) and carbon-in-pulp (CIP) processes. The gold may be eluted from carbon fines with alkaline eluent having a low oxidation reduction potential (ORP). Value added products may be obtained from the extracted carbon fines.

### FIELD OF THE INVENTION

The present invention relates to the recovery of gold from carbon, especially carbon fines, and to the production of value added products. Such fines may be produced in processes for the recovery of gold from ores, especially from carbon-in-leach (CIL) and carbon-in-pulp (CIP) processes. In particular, the gold is in the form of gold cyanide. In addition, the present invention relates to the recovery of gold from carbon fines in which, after the recovery of the gold, the carbon is used for the production of value added products, for example graphite and graphene. In particular embodiments, the gold-containing carbon fines are not subjected to a combustion or incineration process, which avoids or reduces the release of green house gases into the atmosphere. The reduction in the amount of green house gases released into the atmosphere is a significant benefit towards the need to control or reduce atmospheric warming.

### BACKGROUND TO THE INVENTION

Gold mining operations generate significant amounts of carbon fines waste, especially as part of processes to recover gold and base metals from ores containing those metals. The gold content of carbon fines waste may be of the order of 10 oz of gold per tonne in some instances, a significant source of potential revenue in the mining of gold ores. In known processes, the carbon tends to be incinerated or subjected to a combustion process at elevated temperatures prior to recovery of the gold by cyanidation. Combustion or incineration of carbon has negative environmental effects associated with the CO₂ gas emissions.

A process for recovering gold from fine carbon residue in a gold recovery process is described in U.S. Pat. No. 6,228,334B1 of E. M Hill et al, dated 8 May 2001, Gold-loaded fine carbon residue is mixed with activated coarse carbon and an aqueous solution of a gold-transfer agent, and then separated in the process. Gold is recovered by leaching and the activated carbon is recycled in the process.

The use of ion exchange resin to leach gold from carbon fines is described in US Patent Application 2016/0208361A1 of V. Yahorava et al, published 21 Jul. 2016.

A process for recovering gold is described in Canadian Patent Application 2861419 of K. Hatano et al, published 25 Jul. 2013. The process comprises leaching gold with an acidic leach that includes chloride and/or bromide anions and copper and/or iron cations. The gold is adsorbed, as gold chloride and/bromide, with activated carbon, which is eluted with alkali solution to obtain concentrated gold solution.

A process for regenerating activated carbon loaded with gold using a caustic solution of sodium sulphide is described in U.S. Pat. No. 2,579,531 of J. B. Zatra, dated 25 Dec. 1951. It is stated that, in general, the solution should contain from 1 to 5% sodium sulphide and from 2 to 8% sodium hydroxide. Preferably, the caustic sodium sulphide solution is maintained at a content of about 3% sodium sulphide and 4% sodium hydroxide based on the total weight of solution.

Processes for the recovery of precious metals, including mercury and gold, from carbon fines are known, for example that described in US Published Application 20160151759 of D. W. Kappes, published 2 Jun. 2016. Carbon is converted to ash.

Recovery of gold from gold-bearing ores by leaching with cyanide in alkaline medium is well known. The use of carbon in leach (CIL) and carbon in pulp (CIP) is also well known.

One method of extraction and recovery of gold from ores involves the use of cyanide in caustic medium as the leaching agent. It has been known for decades that in such processes the gold could be adsorbed by activated carbon, especially in heap leaching, and the use of carbon is a common method of adsorbing gold in heap leaching. Carbon is agitated with the leach solution to adsorb the gold, After separation steps, the gold is eluted with a solution of sodium hydroxide and recovered. Gold may also be recovered using columns of activated carbon to adsorb the gold. Although the carbon may be recycled in the process, eventually gold-containing spent carbon fines are usually incinerated, which contributes to green house gases in the atmosphere.

Thiosulphate leaching is also used in the extraction of gold from gold-bearing ores. While not as efficient as cyanide, thiosulphate offers benefits of lower toxicity, and hence less negative publicity, and greater efficiency. However, traditional use of carbon for adsorption tends to be not favoured in thiosulphate leaching.

A preferred method of leaching gold from gold-bearing ores is that using mixed chloride technology, as described in U.S. Pat. No. 9,732,398 of V. I. Lakshmanan, R. Sridhar and M. A. Halim, issued 8 Apr. 2013.

Carbon fines may be used in the production of battery-grade graphite and graphene for use in, for example, rechargeable storage batteries. Several patents have been published on the use of graphite and graphene in battery technology. An example is U.S. Pat. No. 8,691,441B2 of Aruna Zhamu et al, issued 8 Apr. 2014.

There is a need for processes for the recovery of metals from carbon fines that reduce the introduction of green house gases into the environment. Current technology uses incineration to remove carbon from mixtures of precious metals and carbon fines. There is also a need for processes that recover gold and precious metals from carbon fines and further to provide for the production of value added products from the resultant gold-free carbon fines.

### SUMMARY OF THE INVENTION

The present invention is directed to processes for the treatment of carbon fines containing precious metals, including gold. In embodiments, there is minimal effect on the environment through the introduction of green house gases.

The present Invention provides a process for the recovery of gold from carbon fines waste under reducing conditions in alkaline medium. Subsequent to recovery of gold the carbon fines may be subjected to steps to produce value added by-product. The carbon fines may be generated in gold extraction processes, wherein gold is adsorbed as cyanide complexes.

In a preferred embodiment, the gold subjected to recovery from the carbon fines is in the form of gold cyanide.

In a preferred embodiment, the gold is eluted from the carbon fines with an alkaline solution (eluent) having an oxidation reduction potential (ORP) of between −100 mV and −1000 mV, particularly between −400 mV and −800 mV, and more specifically between −500 mV and −750 mV.

In a further embodiment, the eluent contains an alkaline metal sulphide as the reducing reagent, especially at least one of sodium sulphide, potassium sulphide or lithium sulphide.

In another embodiment, the eluent is alkaline metal hydroxide of 0.01 M to 1.0 M, more specifically 0.05 M to 0.5 M of at least one of sodium hydroxide, potassium hydroxide or lithium hydroxide.

In an embodiment, the elution of gold from carbon fines has a carbon (S) to eluent (L) weight ratio in between 1:40 and 1:2, especially between 1:20 and 1:5. Preferably, the elution is carried out at ambient temperature. It is preferred that the elution is carried out for 0.5-5.0 hours, especially for 1.0-4.0 hours. It is preferred that the elution of gold from carbon fines is carried out at ambient temperature and atmospheric pressure.

Recovery of gold may be by precipitation or electrowinning. Recovery may be from an eluate obtained by a process of eluting gold according to the present invention, especially with recycling the resulting eluent to the elution stage.

Value added by-products, for example battery grade graphite and graphene, may be formed from the carbon fines obtained by the process of recovering gold according to the present invention.

### DESCRIPTION OF THE INVENTION

The present invention relates to the recovery of gold from carbon, especially carbon fines, and for the production of value added products. Such fines may be produced in known processes for the recovery of gold from ores, especially from carbon-in-leach (CIL) and carbon-in-pulp (CIP) processes. Cyanidation is used as a lixiviant to leach gold from ores or other solid matrix. The resultant gold cyanide complex is then separated from the resultant solution and adsorbed onto activated carbon. In the CIL process, the carbon fines are added to the leach reaction vessel, and adsorption takes place during the leach. In a CIP process, the leaching and adsorption are separate steps in the process, and carried out in separate vessels. The resultant gold-containing carbon fines from such processes may be subjected to the process of the present invention. Gold-containing carbon fines may be obtained from other gold extraction processes.

The extraction of gold from gold-bearing ores may be carried out using sodium cyanide as the leaching agent, even though the resultant presence of cyanide in tailings or other effluent from such processes is a significant environmental hazard. Other gold extraction processes are known, and in embodiments gold bearing products obtained may be adapted for use in the process of the present invention.

An alternate process for the extraction of gold from a gold-bearing material is the process of Lakshmanan et al described above, which obviates environmental consequences of other gold leaching processes. The alternate process involves leaching the gold-bearing material with a lixiviant of hydrochloric acid and magnesium chloride at atmospheric pressure at a temperature of at least 90° C. and an ORP of at least 900 mV, This process is described in detail in the aforementioned patent of Lakshmanan et al. Products from such a process could be adapted for use in the process of the present invention.

In the process of the present invention, the gold-bearing material is in the form of fine gold particulate in admixture with carbon fines. The gold is extracted from the gold-bearing material using a process for the extraction of gold, for instance the processes described above. Gold extraction processes, especially the CIL and CIP processes mentioned above may be used. Steps are then taken to recover the gold.

The present invention provides a process for the recovery of gold from carbon fines waste under reducing conditions in alkaline medium and subjecting the eluted carbon fines to steps to produce value added by-product. The carbon fines may be generated in gold extraction processes, wherein gold is adsorbed as cyanide complexes, as noted above.

In the process of the invention, the gold is eluted from the carbon fines with a eluent that is solution of an alkali metal hydroxide, especially sodium, potassium or lithium hydroxide, and most especially sodium hydroxide. The gold is preferably in the form of gold cyanide. The eluent of alkaline metal hydroxide is 0.01 M to 1.0 M, more specifically 0.05 M to 0.5 M. In addition, the eluent has an oxidation reduction potential (ORP) of between −100 mV and −1000 mV, between −400 mV and −800 mV, and more specifically between −500 mV and −750 mV, The ORP may be obtained using an alkaline metal sulphide as the reducing reagent, especially at least one of sodium sulphide, potassium sulphide, sodium hydrosulphide or lithium sulphide. Sodium sulphide is preferred. Recycle of components of the leach is important for economics of the process, and thus mixing of cations is less preferred than the use on just one cation.

In embodiments of the invention, the elution of gold from carbon fines has a carbon (S) to eluent (L) ratio of between 1:40 and 1:2, especially between 1:20 and 1:5. Preferably, the elution is carried out at ambient temperature. It is preferred that the elution is carried out for 0.5-5.0 hours, especially for 1.0-4.0 hours. It is preferred that the elution of gold from carbon fines is carried out at ambient temperature and atmospheric pressure. In preferred embodiments, the aqueous solution of low ORP has 0.1 to 0.8% of sodium sulphide in 0.5-1.25% sodium hydroxide.

Recovery of gold may be by precipitation or electrowinning from an eluate solution obtained by a process of eluting gold according to embodiments of the present invention, especially with recycling the resulting eluent solution. Other processes for the recovery of gold from solution are known.

Value added by-products, for example battery grade graphite and graphene, may be formed from the carbon fines obtained by the processes for recovering gold according to embodiments of the present invention.

The carbon fines remaining after extraction may then be subjected to steps to convert the carbon into value added material, e.g. graphite or graphene. The value-added material may be other material, which will be apparent to those skilled in the art.

The processes of embodiments of the present invention provide an environmentally friendly method of extraction of gold from carbon fines. In particular, the process may be operated so that the process does not involve incineration of carbon before or after recovery of gold from the carbon fines. The process also allows for production of value added products.

The present invention is illustrated by the following examples.

### Example 1

Gold-loaded carbon fines were prepared by contacting activated carbon fines with a standard gold cyanide solution of pH 11.0 at a carbon to aqueous weight ratio of 1:10 in a rolling bottle for about 24 hours at ambient temperature. The gold-loaded carbon fines were filtered, washed with pH adjusted water (pH approximately 11), dried and pulverized prior to analyse. About 334.7 mg/kg of gold had been loaded to the carbon fines.

Eight batch tests (Test #1-8 in Table 1 below) were conducted on the gold-loaded carbon fines, at a ratio of gold-loaded carbon fines (S) to eluent (L) ratio of 1:20. The eluent was 0.5 M NaOH, with the oxidation reduction potential (ORP) of the eluent adjusted as shown in Table 1. Each of these test were completed at ambient temperature for 4.0 hours using a magnetic stirrer and at atmospheric pressure,

TABLE 1

| Test | S:L ratio | Time | ORP | NaOH | Au Elution |
|---|---|---|---|---|---|
| Number | w/w | h | mV | M | % |
| 1 | 1:20 | 4.0 | −173 | 0.5 | 9.7 |
| 2 | 1:20 | 4.0 | −134 | 0.5 | 15.4 |
| 3 | 1:20 | 4.0 | −407 | 0.5 | 52.7 |
| 4 | 1:20 | 4.0 | −641 | 0.5 | 94.1 |
| 5 | 1:20 | 4.0 | −649 | 0.5 | 94.3 |
| 6 | 1:20 | 4.0 | −680 | 0.5 | 97.5 |
| 7 | 1:20 | 4.0 | −642 | 0.5 | 97.4 |
| 8 | 1:20 | 4.0 | −709 | 0.5 | 98.8 |

The results in Table 1 show that the elution of gold increases with decreasing ORP. These results further show that >94% loaded gold can be eluted from the carbon fines with 0.5 M NaOH solution of about −640 mV.

### Example 2

Four elution tests (Test #9-12) were carried out using ratios the gold-loaded carbon fines (S) to eluent (14 ratios of 1:40, 1:20, 1:10 and 1:5 in 0.5 M NaOH solutions. Oxidation reduction potentials of eluents (0.5 M NaOH) were −629 mV and −664 mV with an average of about −641 mV. Each test was conducted at ambient temperature for 4.0 hours. Results of these tests are shown in Table 2.

TABLE 2

| Test | S:L ratio | Time | ORP | NaOH | Au Elution |
|---|---|---|---|---|---|
| Number | w/w | h | mV | M | % |
| 9 | 1:40 | 4.0 | −629 | 0.5 | 95.5 |
| 10 | 1:20 | 4.0 | −642 | 0.5 | 96.1 |
| 11 | 1:10 | 4.0 | −628 | 0.5 | 95.8 |
| 12 | 1:5 | 4.0 | −664 | 0.5 | 93.2 |

The results show that >93% loaded gold can be eluted at the S/L ratio of 1:5.

### Example 3

Elution batch tests #13 to 16 were conducted by varying the residence time from 0.5 h to 5.0 h to evaluate the effect of residence time on gold elution. Each test was carried out at the S/L ratio of 1:20 with 0.5 M NaOH solution at ambient temperature. Oxidation reduction potentials of the eluents of these tests were adjusted to between−633 mV and −652 mV with an average of about −643 mV. Results of these tests are shown in Table 3.

TABLE 3

| Test | S:L ratio | Time | ORP | NaOH | Au Elution |
|---|---|---|---|---|---|
| Number | w/w | h | mV | M | % |
| 13 | 1:20 | 0.5 | −638 | 0.5 | 95.6 |
| 14 | 1:20 | 1.0 | −652 | 0.5 | 97.4 |
| 15 | 1:20 | 2.5 | −649 | 0.5 | 95.9 |
| 16 | 1:20 | 5.0 | −633 | 0.5 | 95.2 |
| 10 | 1:20 | 4.0 | −642 | 0.5 | 96.1 |

The results show that over 97% gold can be eluted within 1.0 h using 0.5 M NaOH solution at about −652 mV at ambient temperature.

### Example 4

Four batch tests, #17-20, were carried out on the gold loaded carbon fines by varying the concentration of NaOH in the eluent from 0.2 M to 0.8 M to evaluate its effect on gold elution. These tests were carried out at the S/L weight ratio of 1:20 at ambient temperature for 4.0 h. The equilibrium redox potentials of the aqueous phases were varied in between −684 mV and −677 mV with an average of about −680 mV. Conditions and results of these tests are shown in Table 4.

TABLE 4

| Test | S:L ratio | Time | ORP | NaOH | Au Elution |
|---|---|---|---|---|---|
| Number | w/w | h | mV | M | % |
| 17 | 1:20 | 4.0 | −678 | 0.2 | 95.6 |
| 18 | 1:20 | 4.0 | −684 | 0.4 | 95.4 |
| 19 | 1:20 | 4.0 | −677 | 0.6 | 97.4 |
| 20 | 1:20 | 4.0 | −679 | 0.8 | 97.0 |

The results suggest that ˜95.6% gold can be recovered with 0.2 M NaOH solution at about −678 mV. These results further indicate that oxidation reduction potential plays a key role for the elution of gold from carbon fines.

1. A process for the recovery of gold from carbon fines under reducing conditions in alkaline medium having a low oxidation reduction potential (ORP).

2. The process of claim 1 in which the gold is in the form of gold cyanide.

3. The process of claim 2 in which the alkaline medium has an oxidation reduction potential (ORP) of between −100 mV and −1000 mV, particularly between −400 mV and −800 mV,

4. The process of claim 3 in which alkaline medium contains an alkaline metal sulphide as reducing reagent, especially at least one of sodium sulphide, potassium sulphide or lithium sulphide.

5. The process of claim 4 in which the alkaline medium is alkaline metal hydroxide of 0.01 M to 1.0 M, more specifically 0.05 M to 0.5 M, of at least one of sodium hydroxide, potassium hydroxide or lithium hydroxide.

6. The process of claim 5 in which the alkaline medium has 0.1-0,8% sodium sulphide and 0.5-1.25% sodium hydroxide.

7. The process of claim 3 in which the recovery of gold from carbon fines is carried out at ambient temperature and atmospheric pressure.

8. The process of claim 3 in which at least one of graphite and graphene is formed from the carbon fines subsequent to the extraction of gold.

9. The process of claim 3 in which the carbon fines after elution of gold is used in the production of battery materials.
